(19) United States
(12) Patent Application Publication
(10) Pub. No.: US 2019/0317761 A1
(43) Pub. Date: Oct. 17, 2019

(54) ORCHESTRATION OF ELASTIC VALUE-STREAMS

(71) Applicants: Saikant Gade, Aliso Viejo, CA (US); Anoj Pillai, Aliso Viejo, CA (US); Anuchandran Nair, Aliso Viejo, CA (US)

(72) Inventors: Saikant Gade, Aliso Viejo, CA (US); Anoj Pillai, Aliso Viejo, CA (US); Anuchandran Nair, Aliso Viejo, CA (US)

(21) Appl. No.: 16/314,615

(22) PCT Filed: Jul. 3, 2017
(86) PCT No.: PCT/US2017/040616

§ 371 Date: Dec. 31, 2018

Related U.S. Application Data
(60) Provisional application No. 62/357,505, filed on Jul. 1, 2016.

(51) Int. Cl. G06F 8/77

(52) U.S. Cl. CPC G06F 8/77

(57) ABSTRACT

A novel approach for end-to-end support of enterprise system lifecycles that enhances the velocity of delivery through best fit models, integration capabilities, transparency, and applied learning to provide dynamic orchestration and automation of development and deployment capabilities.

### CROSS-REFERENCE TO RELATED APPLICATION(S)

This application claims priority to U.S. Provisional Patent Application No. 62/357,505, filed Jul. 1, 2016, which is hereby incorporated by reference herein in its entirety.

### BACKGROUND OF INVENTION

The current field of DEVOPS (as that term is understood by those skilled in the art of software development and information technology (IT) operations) arises from the integration of concerns of two independent teams responsible for Information Systems (Dev & Ops) in commercial enterprises, particularly large scale environments that contain as much as hundreds of active systems or platforms and require over a thousand employees to create and maintain and maintain software, and to provision and support IT environment and communication networks.

Previously, large Enterprises were challenged by the scope and scale of their internal systems and supporting infrastructure. The business was often organized in independent groups responsible for Product Portfolios, Sales, Customer Relations, Finance, Operations, Supply Chain, Inventory, Information Systems and other areas. Each group used automation to their advantage; creating multiple copies of data in duplicate databases, which necessitated high effort to build interfacing systems or other infrastructure to keep all data in a synchronized state. Multiple customer channels resulted in various technical stacks and architecture across the Enterprise landscape. Vendors creates custom solutions in an attempt to lock in customers by making it expensive to change, and over time the systems and set of system interfaces became very brittle and expensive to maintain.

Some of the key challenges that deter large enterprises today to deliver value and software assets efficiently and with speed can be categorized as:
Organizational silos that disconnect business and IT
Rigid IT architecture, and operational infrastructure
Heavily regulated change management process
Inability to monitor and feedback customer or end-user needs and wants.

### Current Practices

From 2012 onward, DevOps that promotes a shared view of the challenges faced by Development teams to make and test IT system changes to meet business competitive and regulatory needs, in parallel with the challenges faced by Operations in managing the various IT environments, and ensuring the availability, safety, security, and accuracy of the production IT system for customers, partners, and employees.

Vendors have responded by producing software tools that run under open source platforms and databases, or are hosted externally. Enterprise planners, architects, and executives, however, now face competing pressures to make changes much more quickly to remain competitive, collect increasing amounts of detailed data on customer actions, provide actionable analytic insights, and support multiple customers channels across Stores, Internet, and Mobile wireless devices. In many industries, the boundary of the network is being pushed out to new intelligent devices as part of the all-encompassing Internet of Things.

Software changes are generally approved after a business evaluation of the cost, benefit, and rationale for the change versus alternative options. Each change is defined by (a) the set of objectives or scope of work, (b) the impacts to existing systems, environments, and business practices across organization groups. Typically, hundreds or thousands of unique software changes are grouped into a single work stream that is planned and built according to a well-defined schedule, and tested jointly in so-called integrated environment to verify everything is working and validate the results are correct, without any unintended consequences. Systems changes also require various forms of testing to ensure that the end-to-end network and system performance can handle the estimated volumes, and throughput required by the business. Most enterprises will additionally push the systems to a point of failure in order to understand how and when that might occur and to prepare so called disaster recovery plans and procedures including data copies and alternate facilities for business continuity in the most adverse situations possible.

DEVOPS groups are responsible for making these software changes as efficiently as possible in terms of speed to market, cost to deliver, long term cost to maintain, and assured quality of results, safety and security of use.

### Current Deficiencies of DEVOPS

DevOps as a transformative concept addresses only part of these fundamental problems through an aggregation of people, process and technological practices, such as:
Adoption of agile methodology,
Continuous integration (CI),
Deployment automation,
Adoption of micro-service architecture,
Lifecycle and application monitoring
Infrastructure automation through infrastructure as a code.

However, the key practices that DevOps promotes remains centered on the IT Software Development Lifecycle. These manifest as:
Business groups, IT groups such as Design, Architecture, Development, QA Test, Operations are structured and interact in a workflow sequence;
Different groups have different processes, standards and use different tools;
Same routes are taken for different business services technologies or regions;
Requires many skills and specialists to manage and coordinate and work synchronously. (E.g. the adage that you cannot develop faster than you can test).

The result now is that the Enterprise software development and operations teams (or DEVOPS groups) face a challenge of requiring mastery over multiple specialist software tools, specialist software languages, rapidly changing systems and interfaces, more not fewer platforms, and new technology solutions, components and environments to handle increased network and communications challenges, and increasing volumes and loads on network bandwidth.

Additional Problems include:

DEVOPS teams using specialists tools lack a single integrated view of the process and current status. Manual intervention is required which takes time to assemble.

Different types of changes are often delayed if a given release is impacted by one component; it is difficult to quickly unbundle selected features or changes, so overall efficiency is undermined.

It is difficult to understand mixed Enterprise environments, cope with different project standards, and department processes across the organization, so the DEVOPS process overhead is increasing cost and impacting schedules.

Business integration with the DEVOPS is often lacking; multiple handoffs are still required between business and IT groups, even if the DEVOPS process is a well-coordinated or automated.

### SUMMARY OF THE INVENTION

The Unified Platform solution set forth herein includes the following goals:
Improve the speed of workflow/eliminate management delays that translate into development and deployment delays;
Allow managing heterogeneous environments from a single platform;
Provide a single point of control over variety of tools and environments;
Be Tool/technology agnostic;
Reduce or eliminate current manual steps and inefficiencies;
Provide flexible release scheduling;
Incorporate flexible or tailored levels or degrees of validation for a change;
Consolidate project and cross-project or program status in a central control system derived from multiple sources;
Incorporate applied intelligence/learning patterns to optimize decisions and enable proactive course corrections.

### BRIEF DESCRIPTION OF THE DRAWINGS

FIG. 1 is process block diagram illustrating the various components and interactions providing the solution for orchestration of elastic value streams.

FIG. 2 is a block diagram illustrating the Pipeline composition of Pipeline Hops, including Activity footprint.

FIG. 3 depicts an example of a Change Pipeline in the preferred embodiment of the solution.

FIG. 4 illustrates the decomposition of a Project into a set of one or more Deployment Pipelines.

FIG. 5 illustrates the contributory nature of the Hop states to overall the Pipeline state via aggregation and rollup logic.

FIG. 6 depicts the set of States and Memory States of the preferred embodiment.

FIG. 7 depicts the System Data relationships for the preferred embodiment by Subject Area.

FIG. 8 depicts a sample of Integration end points for the solution.

FIG. 9 illustrates the type and variety of vendor tools and products connected under this platform to provide a central point of control and information gathering and distribution.

### DETAILED DESCRIPTION OF THE INVENTION

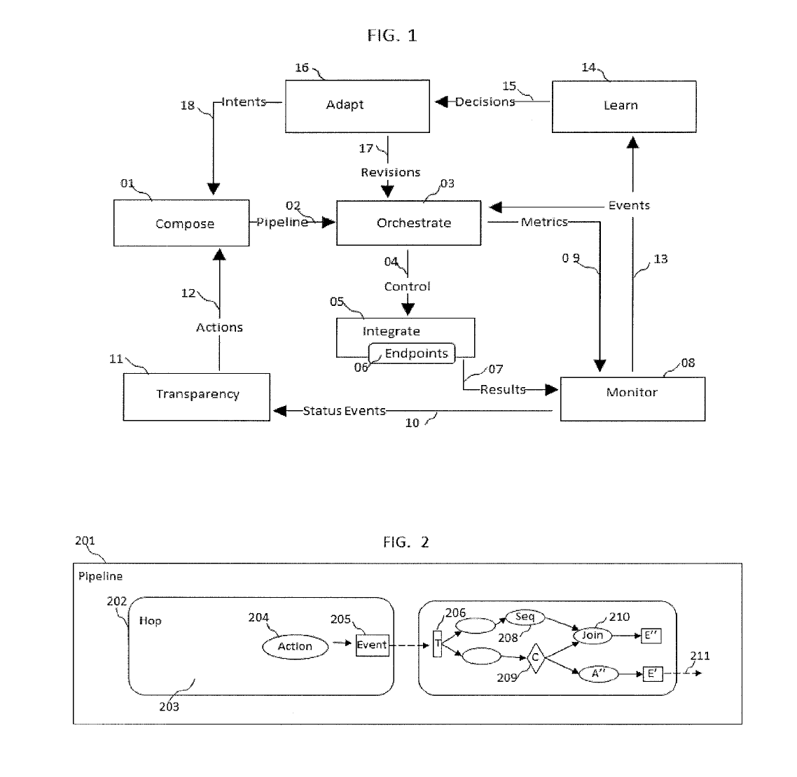

FIG. 1 is a process block diagram illustrating various components and interactions providing a solution for orchestration of elastic value streams. The Compose module 01 creates a Pipeline 02 for the Orchestrate module 03. As described in detail in subsequent sections the Pipeline 02 is a composite element for tracking, managing and reporting status across two major Enterprise functions: namely Change Management processes, and the Development-Deployment processes. The Orchestrate module follows the prescribed business process logic and issues control Commands 04 to the Integration module 05 for certain automated steps. Integrate 05 manages a set of physical interfaces to the system endpoints including virtual, dedicated, and cloud-based environments and vendor toolsets or products used within the Enterprise for Business requirements tracking, software development, quality assurance including test data management, operations deployment and monitoring of software, and problem management.

In further detail, each component of FIG. 1 is described separately below:

Compose Function

Compose 01 generates the initial layout for a Change Pipeline 301 and Deployment Pipelines 402. The layout of a given Deployment pipeline is based on the attributes of particular approved business change. This layout is composed of the sequence and duration for the set of Hops 202 planned to complete all activities 203. Composition results in the creation of the Pipeline schedules, dependencies, and associated business logic of a given pipeline 201.

Orchestrate Function

Orchestrate 02 manages the step-by-step completion of a given Pipeline (301 and 402) by ensuring the Hops (references 301, 318, and 403) are completed in sequence, handling any branching, forking, or conditions required in the Pipeline business process logic 203. Orchestration 02 results in the real-time update of the Pipeline state 501 as a net accumulation 505 and rollup 506 of the statuses of the underlying elements within the given footprint 203 of the Hop and the Hop 202 itself, respectively.

Integration Function

Integration 03 provides the access to external DEVOPS tools 01, and environments through standard APIs (application programming interfaces) or custom SDKs (software development kits). Integration provides both Control 04 and Monitoring channels for metrics 09 and results 07. The Control channels 04 allow for automating manual work and engaging automated tools, while the monitoring channels enable collecting job results 07 and environments status into the Unified Platform solution. Integration function 03 results in real-time control of the external end-points 06.

Monitoring Function

Monitoring 08 collect the metrics 09 from various end-points 06 through the integration function 05 and feeds subsequent events 13 to the Learning 14 and Orchestration 03 functions. Monitoring 08 results in the real time update of the Pipeline status events 10 in the Transparency 11 module.

Transparency Function

Transparency 11 enables the visibility of the underlying tools and endpoint 06 availability and performance for all the deployment pipelines 02 currently operating in the system, or active within a project 401. The metrics 09 and results from multiple sources 07 are gathered in real-time and aggregated to provide a consolidated view that is rendered through configurable graphical dashboards. The default dashboard views can also be customized by the users and their roles.

Learn Function

Learn 14 maintains the system libraries for Patterns, Trends, and Key Event scenarios, collectively 711 and updates various triggers 714 such as threshold conditions, or configuration parameters 708, and pipeline models 709 in the Blueprint Repository 702. The Learning 14 function maintains the overall platform history and upgrades the platform predictive and reactive capabilities in real time. Learning decisions 15 dynamically alter and optimize the course of future Orchestration steps and logic.

Adapt Function:

Adapt 16 revises the current set of Pipelines 02 including hops and schedules 713 based on forecasts, predictions, and proactive triggers from applied Learning. Learning decisions 15 that apply to active pipelines 02 are passed to the Adapt module 16 for execution. Adaption 16 results in the real time revisions 17 that realign and modify the pipeline schedules 713 and state 501.

The preferred solution handles the end to end set of activities for an Enterprise change as either a Business Change or a Development project. Both scenarios are handled in the same fashion, namely as one or more independent Pipelines. Each Pipeline is managed to completion within the solution. FIG. 2 illustrates the composition of a Pipeline 201. A given project may have one or more Pipelines 201 but each Pipeline 201 is scheduled and can be completed independently.

Each Pipeline 201 includes one or more Hops. A Hop 202 is treated as a single stage referred to herein as a footprint 203. Each such footprint 203 is composed of a set of activities as will be familiar to those of ordinary skill familiar with Business process modeling (BPML) or use of BPML standard diagramming techniques (or similar techniques) for such business process models. According to an embodiment, the activity types used include actions 204, events 205, triggers 206, Sequences 208, conditions 209, and Joins 210. As illustrated, an action 204 is seen to result in a completion event 205. The occurrence of the completion event is seen as the event firing 212 in a fashion that triggers the next scheduled Hop 202. The initial trigger 206 of a HOP 202 will initiate one or more specified Actions 204; in this manner a Trigger within the solution acts as a standard Branching function to allow parallel activities that are not dependent on each other for any precondition. One action 204 completing may lead to a Sequential action 208—in this regard such sequential action can have a precondition of the preceding action completing and can be decomposed into such a condition 209 followed by an action 204 (A″). The join element 210 requires the completion of multiple actions 204 in order to proceed with the next action 204 or event 205. In accordance with the preceding descriptions; it can be understood that the activity footprint 203 can consequently start with a join 210 rather than trigger 206; in such a scenario the set of Hops preceding the active Hop 202 must each complete before the active Hop is triggered.

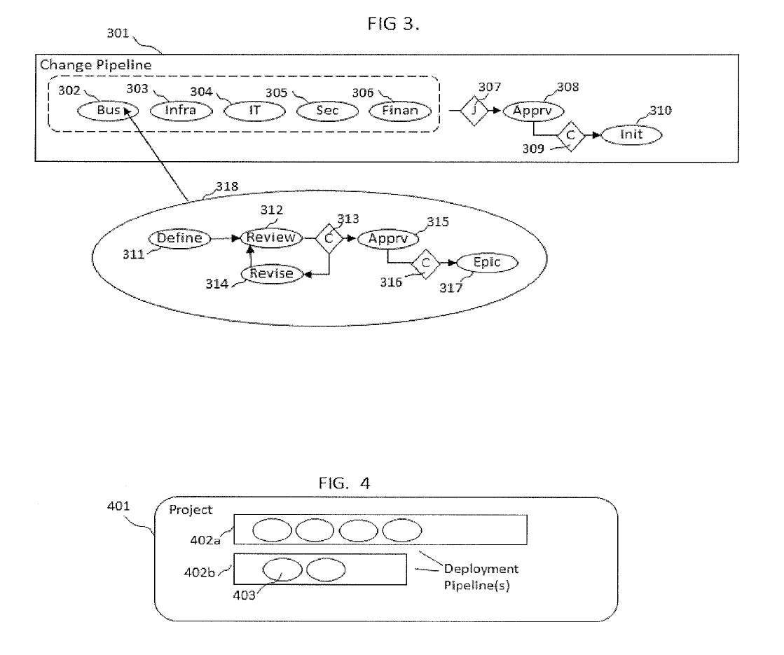

FIG. 3 illustrates an example of a Change Pipeline 301. The Change Pipeline 301 includes seven stages, or Hops 201, in this example. The depicted example, but not limited, show the following Hops 201:
a) Business Epic 302
b) Infrastructure Epic 303
c) Information Technology, or Development, Epic 304
d) Security Epic 305
e) Finance Epic 306

The term “epic” is used as understood by those skilled in the art of software development and information technology operations. These activities allocated to the Business, Infrastructure, Information Technology or Development, Security, and Finance teams respectively for completion.

Each Hop in FIG. 3 is illustrated by the common footprint 318 expected, namely Define 311; Review 312; Revisions to incorporate Review 312 inputs or conditionally 303 a decision to forward for Approval, and conditional 316 upon approval of completing the associated Activity (i e, Epics for activities (312 to 306) as scheduled)

The stepwise progress through the associated business process model of each Pipeline Hop is managed by the Orchestration module 03 of FIG. 1, including the Change Pipeline 301 process depicted above.

The solution framework for Change Pipelines 301 supports the methods needed to transform business change information rapidly into approved software development projects, while maintaining continuous, real-time governance throughout the process.

FIG. 4 illustrates a set of Deployment Pipelines 402a, 402b of an example Project 401.

As described above, a Project 401 is approved and initiated within the Change Pipeline 301.

Each project represents the expected steps in the standard Software Delivery Lifecycle: namely, for IT Development teams to create or modify software code, Quality Assurance teams to verify and validate the software through testing, and Operations staffs to deploy the approved code changes into the production user environments.

According to an embodiment, pipelines are defined and implemented as independent units of work; the solution elasticity comes from two main factors:
(1) allowing the pipeline 402 to be constructed with only the essential numbers of steps or gates to complete, and associating the specific requirements within the overall project to each pipeline in order to eliminate unnecessary dependencies and gates; and
(2) allowing the Pipeline 402 form to be adjusted as needed, with the flexibility of adding activities within a Hop 403, or increasing the number of hops in the case of slippage and re-work, as well as shortening or eliminating activities with a Hop 403 or dropping previously planned Hop 403 due, for example only and not limiting, to perhaps better than expected code quality requiring less testing and little or no rework.

Each such Pipeline 402 has a distinct start date, completion date and current representative state that summarizes the overall status of the underlying Hops 403.

In the decomposition of Pipeline 402, each Hop 403 within the pipeline has a dependent start date, and stop date that fit within the overall pipeline schedule. Each individual Hop 403 has its own representative state based on the status of the activities, or footprint 203, defined within that Hop 403.

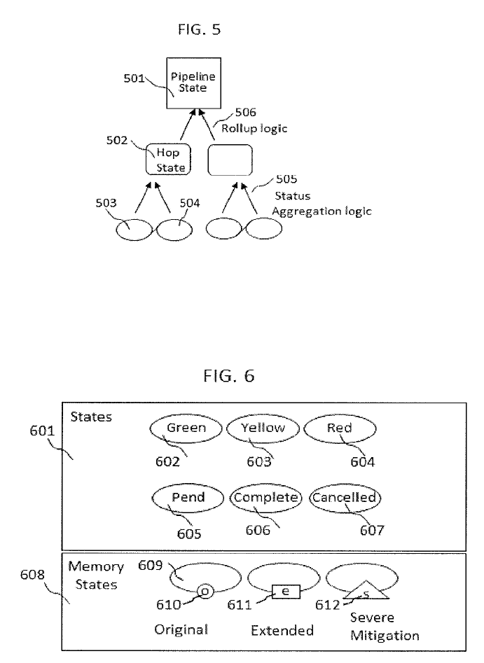

FIG. 5 illustrates the contributory nature of the Hop state 502 to overall the Pipeline state 501. As described earlier above, as each business process step occurs, certain conditions [reference: condition 309, for example] may arise that affect the outcome or status of that element 503 or any dependent element 504 that might be impacted. For example, but not exhaustively, various outcomes include:
a) A start date is missed;
b) A due date is missed;
c) An alert is raised that the progress of the activity might be in jeopardy;
d) An alarm is raised that the outcome of the activity is severely threatened;
e) The Start state is rescheduled to the future (or is slipped based on upstream status);
f) The End date is reset to a future to allow activity to continue;
g) An alert or alarm condition is cleared;
h) The business process model is modified by adding to or modifying the set of planned activities.

The aggregate Hop State 502 is determined at any time by the status aggregation logic 505 employed within the solution as adjusted for any impacts occurring. To those of ordinary skill in the processing of such finite state logic, it is readily understood that the set of discrete events (or event types) can be mapped in a deterministic manner to the set of discrete state transitions allowed for the current scenario from the current State. Similarly, the overall Pipeline state 501 is arrived by summing the contained Hop States 502 into the single representative state 501 using the Rollup logic 506. For example, but not exhaustively, various conditions handled include:
a) the Pipeline state 501 is Red if any Hop state 502 is Red;
b) otherwise, the Pipeline state 501 is Yellow if any Hop state 502 is Yellow;
c) otherwise, the Pipeline state 501 is Cancelled if all Hop states 502 are Cancelled;
d) otherwise, if at least some Hop States 502 are not cancelled and
   (i) if these remaining states 502 are All Pending, then the Pipeline state 501 is Pending,
   (ii) otherwise, if all the remaining states 502 completed then the Pipeline State 501 is Completed,
   (iii) Otherwise, if any of the remaining states 502 is Green the Pipeline state 501 is Green.

FIG. 6 depicts an example set of States 601 and Memory States 609 of the preferred embodiment. According to an embodiment, the States 601 can employ a “stop light” color scheme to indicate the status is proceeding on plan (e.g., normal), under an alert condition, or under an Alarm condition for the colors Green 602, Yellow 603, Red 604, respectively. According to an embodiment, the State indicates the underlying element is pending and has not yet started 605, is completed 606, or is cancelled 607 using the colors blue, dark green, or dark grey respectively. However, it is contemplated that various other colors are suitable and various other color schemes can be used depending on the user interface graphical color standards.

In addition to simple states, aspects of the present disclosure can employ a set of icons and colors for additional Memory States 608. These memory state icons 608 in this example can indicate that until now the underlying element was never off track 610 even after a new schedule has been applied, the element has slipped out of the original schedule 611, or the element was previously in Red status 612. For example—the memory icons can be color-coded as Green, Yellow, and Red for Original 610, Extended 611, or Severely Mitigated 612 cases respectively, as an example only.

The Memory States 608 enhance the learning and adaption capabilities of the system modules and increase the overall transparency of the Enterprise view to business end-user of the system as depicted in FIG. 1 and described earlier above.

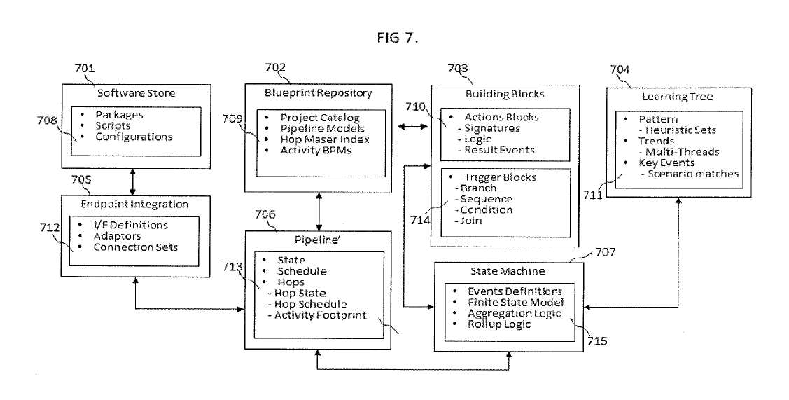

FIG. 7 depicts exemplar System Data relationships by Subject Area. The diagram provides the information viewpoint of the solution, which will be recognized by those of ordinary skills in System Architecting as reflecting at a high level the relationships of the information created, and maintained by system without including every referential link, identifier, primary or foreign key data relationships that comprise a third normal model view of a physical database implementation. The information viewpoint depicted in FIG. 7 is independent of the Functional block diagram of FIG. 1 but reflects the same underlying system operation.

The Software Store 701 enables the Endpoint Integration 705 by providing, but not limited to, Software packages, Scripts, and Configuration files collectively 708. The Blueprint Repository 702 serves as the basis for individual Pipelines 706 by providing but not limited to the Project Catalog, Pipeline Models, Hop Master index, and Activity Footprints (i.e. business process models) collectively 709. Each Pipeline 706 includes collectively: the nested elements for a Pipeline State, schedule, and set of Hops including the Hop State, Schedule, and Activity Footprint 713. The Pipeline status relies on the State machine 707 to manage events and outcomes collectively via Events Definitions, the Finite State Model, Aggregation logic for activities and Hop state Rollup Logic 715. Both of the Blueprint Repository 702 and State Machine are derived from the Building Blocks 703 that provide the meta-data definitions for the defined operations of the preferred embodiment through (a) Action Blocks 702 that carry the signatures, software logic, and Result Events collectively 710, and (b) Trigger Blocks that delineate the Branches, Sequences, Conditions, and Joins collectively 714 for the individual software components that implement the Solution functionality of FIG. 1 including, but not limited to, Compose 01, Orchestrate 03, Monitor 08, Learn, 14, and Adapt 16.

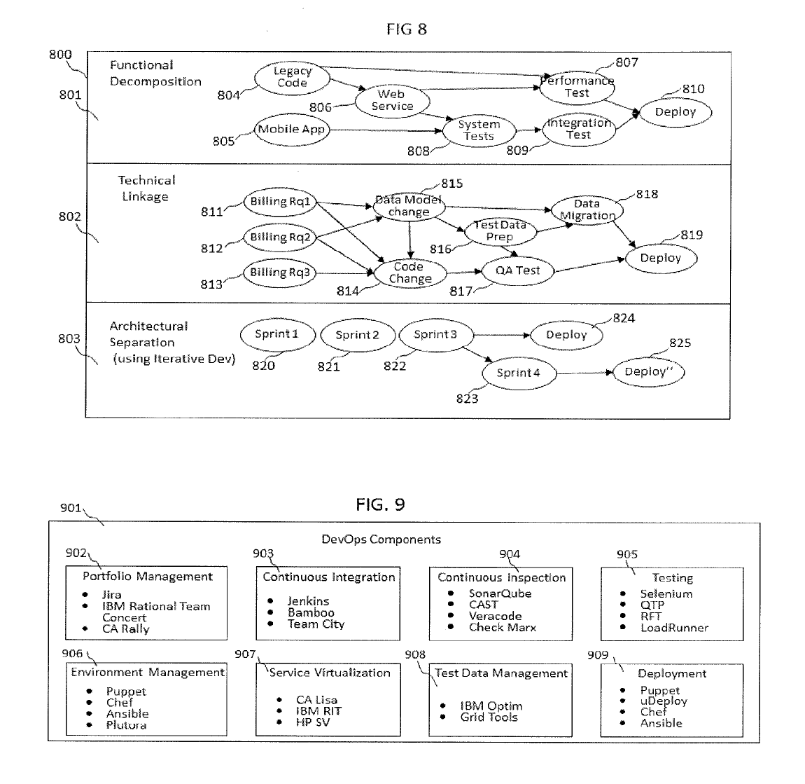

FIG. 8 depicts three examples of pipeline composition 800 based on Function 801, Technical Linkages 802, or Architectural Separation (using Iterative development) 803.

The Solution is not limited to these forms and these examples are provided for convenience only in the evaluation of this present disclosure.

The Pipeline composition 800 based on Function 801 entails, as an example, a project requiring:
a) Legacy code 804 changes
b) Mobile App 805 development
c) Web Service 806 exposed from the new legacy function
d) Performance testing 807 of Legacy system 804 with Web Service 806
e) System Tests 808 for each component in delivery (804,805,806)
f) System Tests 809 for all components collectively (804,805,806)
g) Deployment 810 conditioned on approvals for Integration 809 and Performance 807

The Pipeline composition 800 based on Technical Linkage 802 entails, as an example, a project requiring:
a) Specification of three discrete Billing system changes (811, 812, 813)
b) Data Modeling changes 815 limited to certain requirements 811, 812
c) Code development 814 based on each requirement (811, 812, 813) and data model changes 815
d) Test Data Preparation 816 based on the Data model change 815
e) Data Migration 818 including development, validation, and execution based data model 815 and test data sets 816
f) QA Testing 817 of the delivery package 814 using the Test Data set 816
g) Deployment 810 conditioned on approvals for Integration 809 and Performance 807

The Pipeline composition 800 based on Architectural Separation (using Iterative development) 803 entails, as an example, a project requiring:
a) A series of Sprints 820, 821, 822 operated in the Agile fashion as time boxed efforts by one or more teams
b) An initial deployment 824 based on user approval of a set of pilot features
c) An subsequent Sprint 823 based on the current baseline 822
d) An second deployment 825 based on user approval of the additional feature package 823

As will be recognized by those of ordinary skill in software development the various techniques of iterative development or planned (waterfall) development rely on estimates, function point analysis, or other gauges of effort, and that pragmatic adjustments are expected throughout the life of the development cycles. An example of the solution enables these adjustment in near real-time with full visibility plus with accordant re-adjustment of time schedules, environmental needs, and resource commitments of affected elements that are simultaneously underway or pending.

FIG. 9 depicts a sample of the Integration end points for the solution; these are standard DEV-OPS components 901 that cover a variety of niche purposes, including but not limited, to:
a) Portfolio Management 902, including Jira, IBM Rational Team Concert, CA Rally or other products
b) Continuous Integration 903, including Jenkins, Bamboo, Team City or other products
c) Continuous Inspection 904, including SonarQube, CAST, Veracode, Check Marx or other products
d) Testing 905, including Selenium, QTP, RFT, LoadRunner or other products
e) Environment management 906, including Puppet, Chef, Ansible, Plutora or other products
f) Service Virtualization 907, including CA Lisa, IBM RIT, HP SV or other products
g) Test Data management 908, including IBM Optim, Grid Tools Data builder or other products
h) Deployment management 909, including Puppet, uDeploy, Chef, Ansible or other products

The products are both proprietary and open source tools used today by Enterprises to fill gaps in current product offerings—however, this situation has led to a fractured view of status, and a lack of unified view that is filled by aspects of this solution. The Integration module 05 of FIG. 1 interfaces with each of these tools, collectively viewed as endpoints 06. Referring to FIG. 7, each tool is associated with a specific adaptor 712 and each active interface as a member of the live connection sets 712. In this way, this solution consolidates the activity of the underlying tools and simplifies the reporting and visibility of status through single monitoring element, namely Monitor function 08 of FIG. 1.

The solution's automation capabilities are derived from the Integration 05 function that allows given tools [endpoints] 06 or scripts 708 to be executed without manual intervention at given points in the orchestration 03 sequence for a selected pipeline 02, 201. The automation capabilities of the tools can be extended to cover new, upgraded, or replacement tools in the DEVOPS landscape as needed.

The solution modules Compose 01, Orchestrate 03, Integrate, 05 and Monitor 08 manage the two vital functions of Information Systems within the Enterprise, namely: (a) Business changes from Concept to Realization, as well as (2) the DEV-OPS processes for Development, Testing, and Deployment.

These are accomplished in the framework support of (1) Change Pipelines 301 and associated approvals 308, and (2) Deployment Pipelines 402 for a given project 401.

Additionally, based on the details descriptions provided above, it can be seen that the Change Process can be actively or closely managed, using the available Composition 01, Transparency 11, and Adaption 16 capabilities to spin-off downstream IT projects 310, 401 while continuing to delve deeper in a given change sequence. For example only, but not limiting, a given Change pipeline 301 could result in a single project, a program of several projects approved with a series of spinoffs, or as a whole corporate initiative entailing numerous such projects and programs. Each can be collectively or separately as desired using the solution capabilities and mechanisms for execution, tracking, reporting, and management of the DEV-OPS lifecycle.

Key characteristics from this solution in regard to Business changes or Change Pipeline 301 include:
a) Provides a centralized platform originate and track the business needs to completion.
b) Automatically engages, assigns, and notifies the appropriate corporate teams (ref: 302 303 304 305 306) to analyze and document the required details.
c) Requirements are captured and categorized in a standard Epic 317 formats.
d) Governance bodies are notified immediately of completed work products.
e) The system supports iterative review 312 and revision 314 work cycles 313 until the final approvals 315.
f) Individual approvals streams are merged automatically 307 for final executive approval 308 for the change pipelines from the executive teams.
g) The system libraries 701, 702, 704 maintain historical copies for template use in future changes, which reduces effort over time.
h) Prior change analyses are available within the system and serve as checklists 711 for current work steps.
i) Each step 204 205 in the change pipeline as well as underlying activities 318 are monitored 06 in real-time.

Key Characteristics of the solution is regard to Deployment Pipelines 201 include:

Deployment pipelines are dynamically generated 02 based on the nature 18 of change 801 802 803.

Deployment Pipelines have multiple capabilities and tools 901 working synchronously 203.

Deployment Pipelines are tool and technology agnostic.

Deployment Pipeline Elasticity: Existing Deployment Pipeline is dynamically updated 17 based on the pipeline outcomes 13. For example only, and not limiting: Test cycle with higher than expected defect rates could trigger insertion of additional test phases [i. e. Hops] 202 automatically and create new environments and automation job-streams 204 on the fly; or alternatively for example only, the number of hops 202 or Steps 204 within a Deployment Pipeline will shrink if defect rates are lower than expected and code quality is high.

Applied learning 14 is utilized 18 for Deployment Pipeline 02 composition 01, generation 02 and real-time adjustments 17 during the DEV-OPS lifecycle.

Deployment pipelines 402a, 402b can be independently released to Production.

Deployment pipelines are defined using one of: functional decomposition 801, technical linkages 802, or architecture 803 dependencies.

Prioritization of Deployment pipelines is based on business criticality, or technical or functional linkages.

Key Characteristics of the solution is regard to Transparency 11 include:

Provides a unified view 11 status of pipelines 02: Dashboard metrics gathered from multiple sources and tools 07, 09 and consolidated centrally 10 across pipelines.

Acts as a single control point and summary 11 of enterprise-wide activity, and provides detailed drill down 505, 506 displays of details 503, 504.

Unified Platform FIG. 1 capabilities provide single point of management for the underlying mix of environments, tools, system technicians, schedules or reservations, which are encountered, and cannot be predicted.

Overall, simpler configuration 708 capabilities of endpoints 06 and tools 901 through reuse and automation 04, 05 and tracking whereby only one event signal, or alert, is used to cascade 10, 13 all subsequent control changes 12, 17 within the unified platform that integrates 06 across environments 708 and preferred toolsets 901 and interfaces 712.

Real time adjustment 17 and coordination for improved efficiency as a result of unified platform tracking 08, integration 11, and controls 12, 17.

Associated impacts 13 of an adjustment 17 can affect other parallel but nominally independent workflows.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

What is claimed is:

1. A computer-implemented method of orchestrating elastic value streams, comprising the steps of:
creating, using a computer for a software project, a software deployment pipeline having a sequence of hops, each of the hops representing a footprint having a set of activities of a process model, the set of activities including one or more of an action, an event, a trigger, a sequence, a condition, or a join;
responsive to the action of the set of activities resulting in a completion event in one of the hops, automatically triggering the next hop of the sequence of hops of the pipeline, where the next hop includes a plurality of mutually independent activities executed in parallel such that none of the mutually independent activities depend upon each other for any pre-conditions; and
changing the software project during the software project by having the option to carry out any one or more of the following changes:
adding, shortening, or eliminating one or more activities in any of the hops,
increasing the number of hops within the pipeline, and
adding or removing any of the hops within the pipeline,
wherein the pipeline has a start date, a completion date, and a current pipeline representative state indicative of an overall status of the hops in the pipeline, and each of the hops has a hop representative state indicative of an overall status of the set of activities defined within the hop.

2. The method of claim 1, wherein the plurality of mutually independent activities of the next hop includes an initial trigger that initiates at least one action in each of the mutually independent activities that leads to a sequential action that follows a preceding action, or a condition requiring completion of a preceding action before carrying out a further action, or a join element that requires completion of multiple actions to proceed with a further action or event.

3. The computer-implemented method of claim 1, further comprising:
creating, using the computer or another for the software project, a second software deployment pipeline having a second sequence of hops, each of the hops of the second sequence representing a second footprint having a second set of activities of a process model, the set of activities including one or more of an action, an event, a trigger, a sequence, a condition, or a join;
responsive to the action of the second set of activities resulting in a completion event in one of the hops of the second sequence, automatically triggering the next hop of the second sequence of hops of the second pipeline, where the next hop includes a plurality of mutually independent activities executed in parallel such that none of the mutually independent activities depend upon each other for any pre-conditions; and
changing the software project during the software project by having the option to carry out any one or more of the following changes:
adding, shortening, or eliminating one or more activities in any of the hops of the second sequence,
increasing the number of hops within the second pipeline, and
adding or removing any of the hops within the second pipeline,
wherein the second pipeline has a start date, a completion date, and a current pipeline representative state indicative of an overall status of the hops in the second pipeline, which are distinct from the start date, the completion date, and the current pipeline representative state for the pipeline, and each of the hops of the second sequence has a hop representative state indicative of an overall status of the set of activities defined within the hop of the second sequence, and
wherein the pipeline is part of a DevOps process, and the second pipeline is part of a non-DevOps process, the DevOps process being a software development process that includes software development and information technology (IT) operations.

4. The method of claim 1, wherein the current pipeline representative state is calculated based on a logic conditions, including any one or more of the following:
a state of the current pipeline is indicated to be an alarm if any hop representative state indicates an alarm,
otherwise, the state of the current pipeline is indicated to be an alert if any hop representative state indicates an alert,
otherwise, the state of the current pipeline is canceled if all states of the hop are canceled,
otherwise, if at least some of the states of the hop are not canceled and
(i) if such non-canceled remaining states of the hop are pending, then the state of the current pipeline is indicated to be pending,
(ii) otherwise, if such non-canceled states of the hop are completed, then the state of the current pipeline is indicated to be completed,
(iii) otherwise, if any such non-canceled states of the hop are normal, then the state of the current pipeline is indicated to be normal.

5. A computer-implemented method of automatically detecting outliers from correlated contextually ambiguous data sets, comprising the steps of:
correlating, using a correlation model, a plurality of contextually ambiguous data sets to produce a correlated data set;
identifying an anomaly from the correlated data set by:
applying the correlated data set to a plurality of different and distinct anomaly detection algorithms, each of the anomaly detection algorithms outputting a probability of a given data element of the data sets being an outlier,
adjusting a weight applied to at least one of the outputted probability and associated with a corresponding one of the anomaly detection algorithms,
selecting a final probability of the data element being an outlier based on at least the adjusted weight; and
defining the selected outputted outlier as the identified anomaly of the correlated data set.
